(19) United States
(12) Patent Application Publication
(10) Pub. No.: US 2005/0069284 A1
(43) Pub. Date: Mar. 31, 2005

(54) Apparatus, method and program for recording/reproducing information and information recording medium

(75) Inventors: Akio Tanabe, Tokorozawa-shi (JP); Satoru Kodaira, Tokorozawa-shi (JP); Nobuo Haino, Tokorozawa-shi (JP); Kazutaka Mitsuiki, Tokorozawa-shi (JP); Masami Ichimura, Tokorozawa-shi (JP); Yukimasa Suzuki, Tokorozawa-shi (JP); Hiroshi Tsubonuma, Tsurugashima-shi (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 10/949,558

(22) Filed: Sep. 27, 2004

(30) Foreign Application Priority Data
Sep. 30, 2003 (JP) P2003-341487

(51) Int. Cl. H04N 5/76; H04N 5/781

(52) U.S. Cl. 386/46; 386/125

(57) ABSTRACT

An apparatus for recording/reproducing information includes an externally-inputted information recording device and a reproducing device. An information amount checking device checks an amount of information of record information and/or information as recorded, when recording one of them on a recording medium. A recording capacity checking device checks a recording capacity of the recording medium on which the information is to be recorded. A judging device judges based on the checked information amount and recording capacity, as whether or not the whole of the information can be recorded on the recording medium. A dividing device divides the information into partial record informations each having an amount of information is equal to or smaller than the recording capacity. A partial information recording device repeats record of the partial record informations on the recording medium to record them thereon.

### BACKGROUND OF THE INVENTION

1. Field of the Invention

The present invention relates to an apparatus, method and program for recording/reproducing information and an information recording medium, and more particularly to the apparatus and method for recording, for example, a television-broadcast program, which is obtained through broadcast radio waves on a recording medium such as an optical disc or a recording device such as a hard disc and reproducing such a broadcast program, as well as the program for recording/reproducing such information and the information recording medium on which the above-mentioned program has been recorded.

2. Related Art

A so-called “hard disc recorder”, which has recently been put into practice, records information such as a broadcast program as received, for example, on a built in-hard disc. In addition, desired information is selected from the recorded information and then, transmitted (or copied) to an optical disc such as a DVD (Digital Versatile Disc).

When an amount of information to be copied from information, which has been read out from the hard disc, and transmitted to an optical disc in the conventional hard disc recorder exceeds a recording space in the optical disc to which the copied information is to be transmitted, quality (more specifically, image or audio quality) of the information to be copied is usually reduced for reduction in transmission rate, thus enabling the whole information that is to be copied, to be copied and transferred to a single optical disc.

However, according to the conventional information recording/reproducing apparatus, copying a program having a large amount of information requiring a long-reproducing time on a single optical disc is accompanied by a reluctant acknowledgement of considerable reduction in quality, and the information as copied may provide a seriously damaged information, thus causing a problem.

In addition, the information, which has a large amount of information requiring a long-reproducing time may not be stored in a single optical disc, even when the copying is carried out in a mode of the lowest reduction in quality on the optical disc, thus causing a problem.

### SUMMARY OF THE INVENTION

An object of the present invention, which was made to solve the above-mentioned problems, is therefore to provide an apparatus and method for recording/reproducing information, which permit record the whole of a long-broadcasted program, leading to no need to record the program with a reduction in quality more than necessary, as well as a program for recording/reproducing such information and the information recording medium on which the above-mentioned program has been recorded.

In order to attain the aforementioned object, an apparatus according to an aspect of the present invention for recording/reproducing information, comprises:
an externally-inputted information recording device for recording a record information inputted externally; and
a reproducing device for reproducing at least one of the record information and information as already recorded in the externally-inputted information recording device;
wherein, the apparatus further comprises:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.

In the present invention, the apparatus may further comprise: an informing device for, when it is judged that the whole of said one of the record information and the information as already recorded cannot be recorded on the recording medium, determining a required number of recording media to record the whole of said one of the record information and the information as already recorded and informing same.

In the present invention, the dividing device and the partial information recording device may generate each of the partial record informations without reducing quality of the whole of said one of the record information and the information as already recorded, when it is judged that the whole of said one of the record information and the information as already recorded cannot be recorded on the recording medium.

In the present invention, the dividing device and the partial information recording device may modify the whole of said one of the record information and the information as already recorded in quality thereof so as to enable the whole thereof to be recorded on a predetermined number of recording media and generate each of the partial record informations, when it is judged that the whole of said one of the record information and the information as already recorded cannot be recorded on the recording medium.

In the present invention, the dividing device may uniformly divide the whole of said one of the record information and the information as already recorded so that the amount of information of each of the partial record informations is equal to the recording capacity of the recording medium.

In the present invention, said one of the record information and the information as already recorded may include audio information; and the dividing device may divide the whole of said one of the record information and the information as already recorded, at portions thereof indicative of no sound in the audio information, to generate the partial record informations.

In the present invention, said one of the record information and the information as already recorded may include dynamic image information; and the dividing device may divide the whole of said one of the record information and the information as already recorded, at portions thereof indicative of change in scene in the dynamic image information, to generate the partial record informations.

In the present invention, said one of the record information and the information as already recorded may have a hierarchical structure; and the dividing device may divide the whole of said one of the record information and the information as already recorded, at portions thereof indicative of breaks of unit informations of the hierarchical structure, to generate the partial record informations.

In the present invention, said one of the record information and the information as already recorded may be associated with a managing information on a basis of which said one thereof is to be managed; and the dividing device may divide the whole of said one of the record information and the information as already recorded, based on said managing information, to generate the partial record informations.

In the present invention, the dividing device may divide the whole of said one of the record information and the information as already recorded so that all the partial record informations are identical in an amount of information to each other, to generate the partial record informations.

In order to attain the aforementioned object, a method according to the other aspect of the present invention for recording/reproducing information, is to be carried out in an information recording/reproducing apparatus comprising: an externally-inputted information recording device for recording a record information inputted externally; and a reproducing device for reproducing at least one of the record information and information as already recorded in the externally-inputted information recording device, and said method comprises:
an information amount checking step for checking an amount of information of any one of the record information and the information as already recorded, when recording said any one thereof on a recording medium;
a recording capacity checking step for checking a recording capacity of a recording area of the recording medium on which said any one of the record information and the information as already recorded is to be recorded;
a judging step for judging, on a basis of the amount of information checked and the recording capacity checked, as whether or not a whole of said one of the record information and the information as already recorded can be recorded on the recording medium;
a dividing step for dividing said one of the record information and the information as already recorded into a plurality of partial record informations, each of the partial record informations having an amount of information, which is equal to or smaller than the recording capacity checked; and
a partial information recording step for repeating record of each of the partial record informations on the recording medium to record the partial record informations thereon.

In order to attain the aforementioned object, a program according to the other aspect of the present invention for information record/reproduction, is to be utilized in a computer included in an information recording/reproducing apparatus comprising an externally-inputted information recording device for recording a record information inputted externally; and a reproducing device for reproducing at least one of the record information and information as already recorded in the externally-inputted information recording device, to cause the computer to function as:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.

In order to attain the aforementioned object, an information recording medium according to the other aspect of the present invention has a program recorded thereon for information record/reproduction, which is to be readable by a computer included in an information recording/reproducing apparatus comprising an externally-inputted information recording device for recording a record information inputted externally; and a reproducing device for reproducing at least one of the record information and information as already recorded in the externally-inputted information recording device, said program causing the computer to function as:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.

### BRIEF DESCRIPTION OF THE DRAWINGS

FIG. 1 is a block diagram schematically showing a structure of an information recording/reproducing apparatus according to an embodiment of the present invention; and

FIG. 2 is a flowchart showing a copying processing in the embodiment of the present invention.

### DESCRIPTION OF THE PREFERRED EMBODIMENTS

Now, an embodiment of the present invention will be described in detail below with reference to the accompanying drawings. In the embodiment described below of the present invention, the present invention is applied to an information recording/reproducing apparatus such as a hard disc recorder, which permits to record temporarily a broadcast program information received in the form of broadcast radio wave and then transmit such information to a DVD to record the same thereon. In the embodiment of the present invention, the information recorded on the hard disc is copied to the DVD.

[I] General Structure and Operation

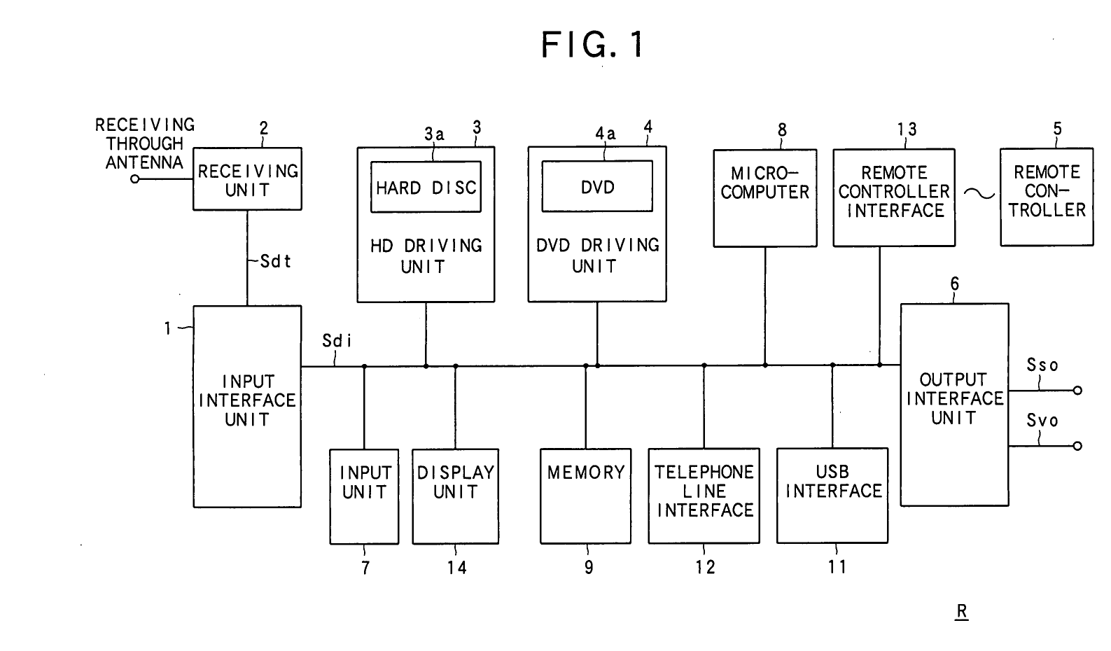

A general structure of the information recording/reproducing apparatus according to the present invention will be described with reference to FIG. 1. FIG. 1 is a block diagram schematically showing the structure of the information recording/reproducing apparatus according to the embodiment of the present invention.

As shown in FIG. 1, the information recording/reproducing apparatus “R” according to the embodiment of the present invention includes an input interface unit 1, a receiving unit 2, a HD (hard disc) driving unit 3, a DVD driving unit 4, a remote controller 5, an output interface 6, an input unit 7, a microcomputer 8, a memory 9, an USB (Universal Serial Bus) interface 11, a telephone line interface 12, a remote controller interface 13 and a display unit 14. An input signal received through an antenna is inputted into the receiving unit 2. The HD driving unit 3 permits to record information on a built-in hard disc 3a serving as an externally-inputted information recording device and reproduce such information. The DVD driving unit 4 permits to record information on a DVD 4a loaded as a recording medium and reproduce such information. The microcomputer 8 serves as a reproducing device, an information amount checking device, a recording capacity checking device, a judging device, a dividing device and a partial information recording device. The display unit 14 serves as an information device. The above-mentioned structural components are connected to each other through a bus 15 so as to ensure the mutual transmission and receipt of information.

Now, the general operation will be described below.

The information recording/reproducing apparatus according to the embodiment of the present invention permits to receive information such as a broadcast program information received in the form of broadcast audio waves (such information will be hereinafter referred to as the “program”), record the information on any one of the hard disc 3a and the DVD 4a, retrieve the recorded program from any one of the hard disc 3a and the DVD 4a to reproduce it, and output signals for the program to the display unit and a loudspeaker.

First, the general operation for recording the recorded program on the hard disc 3a will be described below.

The broadcast audio waves through which the program to be received is carried are received through the not-shown antenna. The received audio waves are subjected to predetermined processing such as a demodulating processing in the receiving unit 2, and then outputted to the input interface 1 in the form of a receiving signal “Sdt”.

Then, the input interface 1 subjects the above-mentioned receiving signal “Sdt” to a pre-set input interface processing to generate a process receiving signal “Sdi”.

A not-shown recording section in the HD driving device 3 records the above-mentioned process receiving signal “Sdi” on the hard disc 3a. The received program is recorded on the hard disc 3a in this manner.

Now, the general operation for recording the recorded program on the DVD 4a will be described below.

When the received program is recorded on the DVD 4a, the same processing as in the case where the received program is recorded on the hard disc 3a, as described above, is first carried out in the receiving unit 2 and the input interface 1. Then, the signal generated through the above-mentioned processing is outputted to the DVD driving unit 4.

A not-shown recording section in the DVD driving unit 4 records the generated signal on the DVD 4a on the basis of a control signal from the microcomputer 8. The received program is recorded on the DVD 4a in this manner.

Now, the general operation for reproducing the information recorded on the hard disc 3a and outputting the same will be described below.

When the information recorded on the hard disc 3a is reproduced and outputted, a not-shown reproducing section in the HD driving unit 3 retrieves the information recorded on the hard disc 3a, on the basis of the control signal from the microcomputer 8 and generates a retrieving signal. Such a retrieving signal is outputted to the output interface 6.

The output interface 6 subjects the retrieving signal to a pre-set output interface processing on the basis of the control signal from the microcomputer 8, to generate an audio output signal “Sso” and a video output signal “Svo”. These signals are outputted to the not-shown display unit and the loudspeaker. The image picture and sound as the information recorded on the hard disc 3a are reproduced in this manner.

Finally, the general operation for reproducing the information recorded on the DVD 4a and outputting the same will be described below.

When the information recorded on the DVD 4a is reproduced and outputted, the not-shown reproducing section in the HD driving unit 3 retrieves the information recorded on the DVD 4a, on the basis of the control signal from the microcomputer 8 and generates a retrieving signal. Such a retrieving signal is outputted to the output interface 6.

The output interface 6 subjects the retrieving signal to the same output interface processing as in the case where the information recorded on the hard disc 3a is reproduced and outputted, to generate an audio output signal “Sso” and a video output signal “Svo” in the same manner. These signals are outputted to the not-shown display unit and the loudspeaker. The image picture and sound as the information recorded on the DVD 4a are reproduced in this manner.

The manual operations as described above for controlling the general operation are carried out, utilizing the remote controller 5 or the input unit 7 including a button operation section. Operation signals corresponding to the above-mentioned manual operations are outputted to the microcomputer 8 from the input unit 7 or the remote controller interface.

The microcomputer 8 generates the above-mentioned control signals for controlling the structural components of the information recording/reproducing apparatus “R” to enable the operations to be carried on the basis of the operation signals in response to the manual operation, and then outputs these control signals to the structural components of the apparatus. Information required for the processing in the microcomputer 8 is outputted to the memory 9 and then stored temporarily therein. The information is read out from the memory 9 to achieve the processing by the microcomputer 9.

When the information is copied from the hard disc 3a to the DVD 4a, the information to be copied is outputted from the HD driving unit 3 to the DVD driving unit 4 on the basis of the control signal. When the information is copied from the DVD 4a to the hard disc 3a, the information to be copied is outputted from the DVD driving unit 4 to the HD driving unit 3 on the basis of the control unit.

[II] Embodiment of the Present Invention

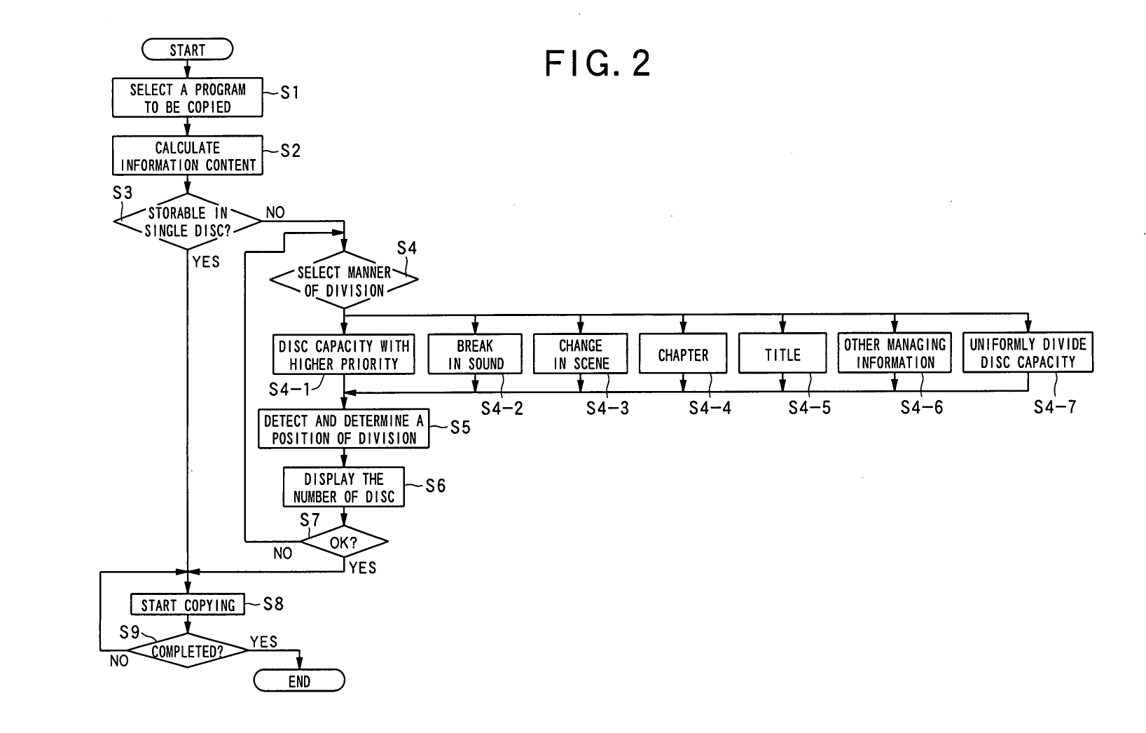

Now, description will be given below of a copying processing of information according to the present invention, which is executed principally in the microcomputer 8, with reference to FIGS. 1 and 2. FIG. 2 is a flowchart showing the copying processing in the embodiment of the present invention.

In the embodiment described below, there is an assumption that the information to be copied from the hard disc 3a to the DVD 4a includes a plurality of titles corresponding to a single movie or a single broadcast program and each of the titles is composed of a plurality of information units, i.e., chapters (for example, commercials in a single program correspond to the chapter, and main parts therein correspond to the different chapter) in combination, and that each of the titles includes a managing information indicative of reproduction order of a dynamic image information included in the title, together with the dynamic image information.

In the copying processing in the embodiment of the present invention, a program to be copied is selected utilizing the input unit 7 or the remote controller 5 (Step S1), as shown in FIG. 2. After such selection, an amount of the information of the whole of the program to be copied is checked (Step S2).

Then, a comparison is made between the checked amount of information and a recording capacity of the DVD 4a as loaded to judge as whether or not the whole of the program to be copied can be recorded on the single DVD 4a, with quality thereof (i.e., image an audio quality) maintained (Step S3). In case where it is judged that the whole of the program can be recorded with quality thereof maintained (YES in Step S3), the copying processing immediately starts (Step S8), and then it is confirmed as whether or not the whole of the program has been copied (Step S9). When the whole of the program has been copied (YES in Step S9), the copying processing according to the embodiment of the present invention is completed. On the contrary, when the copying processing has not as yet been completed (No in Step S9), the system returns to the above-mentioned Step S to continue the copying processing.

When the judgment in Step S3 reveals that the whole of the program cannot be copied to the single DVD 4a (No in Step S3), there is selected a manner of division in which the program is divided into a plurality of sections to record them on a plurality of DVDs 4a with quality maintained (Step S4).

There can be selected any one of the first to seventh copy modes as an optional processing in Step S4 by means of the input unit 7 or the remote controller 5.

More specifically, in the first copy mode, the program is copied and transmitted to the DVD 4a as currently loaded in the maximum amount of information so that the DVD 4a is fully filled with the information, and then there is repeated a series of sub-steps of replacing the DVD 4a with a new DVD and transmitting the remaining information of the program to the new DVD (Step S4-1).

In the second copy mode, there is repeated a series of sub-steps of copying the information of the program to the DVD, suspending temporarily the copying step at a break in sound (voice) in the program to be copied, replacing the DVD 4a with a new DVD, and then copying the program in an amount corresponding to information between the above-mentioned break and the next break (Step S4-2) to the new DVD.

In the third copy mode, there is repeated a series of sub-steps of copying the information of the program to the DVD, suspending temporarily the copying step at a change in scene in the dynamic image information of the program to be copied, replacing the DVD 4a with a new DVD, and then copying the program in an amount corresponding to information between the above-mentioned change in scene and the next change in scene (Step S4-3) to the new DVD.

In the fourth copy mode, there is repeated a series of sub-steps of copying a chapter of the dynamic image information of the program to the DVD, suspending temporarily the copying step, replacing the DVD 4a with a new DVD, and then copying the next chapter of the dynamic image information of the program to the new DVD (Step S4-4).

In the fifth copy mode, there is repeated a series of sub-steps of copying a title of the dynamic image information of the program to the DVD, suspending temporarily the copying step, replacing the DVD 4a with a new DVD, and then copying the next title of the dynamic image information of the program to the new DVD (Step S4-5).

In the sixth copy mode, there is repeated a series of sub-steps of copying the program to the DVD, suspending temporarily the copying step in a position at a predetermined timing according to the managing information corresponding to the program to be copied, replacing the DVD 4a with a new DVD, and then copying the program to the new DVD in an amount corresponding to the information between the above-mentioned position and the next position according to the above-mentioned predetermined timing (Step S4-6).

In the seventh copy mode, the information of the program is copied to a plurality of DVDs 4a, so that the amounts of the information recorded on each of the DVDs 4a are equal to each other (Step S4-7).

The actual positions of division of information of the program to be copied according to the selected copy mode is detected and determined (Step S5). The number of DVDs 4a required to copy the program divided at the positions of division on the DVDs 4a is calculated and displayed on the display unit 14 (Step S6).

Then, a user operates the input unit 7 or the remote controller 5 to confirm as whether or not the number of DVDs 4a as displayed is acceptable (Step S7). When the user confirms that the number of DVDs 4a is acceptable (YES in Step S7), the program is actually copied to the DVDs 4a in accordance with the copy mode as selected, along with division of the program and replacement of the DVD 4a (Step S8). Then, the above-mentioned Step S9 is carried out.

On the contrary, when the user confirms that the number of DVDs 4a is not acceptable (No in Step S7), the system returns to the above-mentioned step S4 so as to enable the user to make a different selection. The above-described steps are carried out based on the newly selected copy mode. The above-described steps are repeated in this manner.

When the user confirms that the number of DVDs 4a required to copy the program in accordance with the copy mode as selected is not acceptable in the judgment of Step S7, the newly selected copy mode, which is different from the copy mode as selected when confirmation of unacceptability is given, is carried out in the new Step S4.

Now, description will be given below of the dividing processing, which is carried out in the above-mentioned Step S8 in accordance with each of the dividing manners of the copy modes.

When the program is divided at the timing of change in scene as described above (see Step S4-3), detection of the timing of change in scene when recording the program is recorded on the hard disc 3a makes it possible to suspend temporarily the copying step at the same timing in the divisional copying process.

When the program is divided at the break in sound as described above (see Step S4-2), detection of the break in sound (more specifically, reduction in sound level to a predetermined lower level) when recording the program is recorded on the hard disc 3a makes it possible to suspend temporarily the copying step at the same break in sound in the divisional copying process.

With respect to division of the program in a position at the predetermined timing according to the managing information corresponding to the program to be copied as described above (see Step S4-6), in case where the program is divided based on the managing information on sound, the timing in variation of parameters such as a channel information of the sound (e.g., a stereo or monaural channel), a recording mode (e.g., an encoding system), a sampling frequency, a quantization constant, a copy control information concerning the sound, attribute of the DVD 4a itself (e.g., a write-once DVD or a rewritable DVD) or emphasis may be utilized as the divisional timing.

Alternatively, in case where the program is divided based on the managing information on video (a dynamic image) (see Step S4-6), an aspect ratio (i.e., a length-to-width ratio) of the dynamic image information, a copy control information concerning the dynamic image, resolution of the dynamic image, a television system corresponding to the dynamic image or a caption may be utilized as the divisional timing.

According to the copying processing utilized in the information recording/reproducing apparatus “R” of the embodiment of the present invention, it is possible to record the whole program on the plurality of DVDs 4a, even when the program has a large amount of information.

In addition, displaying the number of DVD 4a required to copy the whole program makes it possible for a user to prepare the required number of DVDs 4a to complete the copying processing of the program. Accordingly, the copying processing can be completed without interruption due to lack of the required number of DVDs 4a.

Further, the whole program can be recorded on the DVDs 4a without reduction in quality.

According to the dividing manner in the above-mentioned Step S4-1, the information is divided, giving a high priority to the recording capacity of the DVD 4, irrespective of the contents of the program, and the thus divided sections are recorded on the DVDs 4a, thus leading to an effective use of the DVD 4a for the record of the program.

According to the dividing manner in the above-mentioned Step S4-2, the program is divided at the breaks in sound and the thus divided sections are recorded on the DVDs 4a, thus preventing the break in sound from existing on the recorded information on each of the plurality of DVDs 4a.

According to the dividing manner in the above-mentioned Step S4-3, the program is divided at a change in scene in the dynamic image information, to generate the partial recording informations to be recorded and the thus divided sections are recorded on the DVDs 4a, thus preventing the program from being recorded on the plurality of DVDs 4a in a state that the story in the dynamic image information is interrupted.

According to the dividing manner in the above-mentioned Step S4-4 or D4-5, the program is divided at the break in unit information such as the chapter or title and the thus divided sections are recorded on the DVDs 4a, thus permitting manage of information utilizing a hierarchical structure even after the divided sections are recorded on the DVDs 4a.

According to the dividing manner in the above-mentioned Step S4-6, the program is divided based on the managing information and the thus divided sections are recorded on the DVDs 4a, thus permitting manage of information utilizing a hierarchical structure even after the divided sections are recorded on the DVDs 4a.

According to the dividing manner in the above-mentioned Step S4-7, the program is divided and the thus divided sections are recorded on the DVDs 4a so that the amounts of the information recorded on each of the DVDs 4a are equal to each other, thus permitting an easy manage of the whole of the DVDs 4a after completion of the copying processing.

In the above-described embodiment of the present invention, the program is divided and the divided sections are recorded on the DVDs 4a, without reduction in quality of the program. Alternatively, when the number of DVDs 4a to be used for the copy of the program is previously determined, it may be adopt a structure in which the quality of the program is adjusted so that the whole program can be recorded on the previously determined number of DVDs 4a, thus completing the copying processing. In this case, the program is copied, with the quality modified, so that the whole program can be recorded on the previously determined number of DVDs 4a, thus making it possible to record the whole program on the DVDs 4a in a reliable manner even when the number of DVDs 4a that can be previously prepared is limited.

The above-described embodiment of the present invention describes the processing for copying the program, which has been recorded temporarily on the hard disc 3a, on the DVDs 4a. Alternatively, the present invention may be applied to a case where the program as received is recorded directly on the DVDs 4a.

When the program based on the flowchart as shown in FIG. 2 is recorded on an information recording medium such as a flexible disc, or obtained to record through a network such as the internet, reading the above-mentioned program with the use of a general purpose computer to execute the program makes it possible to utilize such a general purpose computer as the microcomputer 8 in the embodiment of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-341487 filed on Sep. 30, 2003 including the specification, claims, drawings and summary is incorporated herein by reference in its entirety.

1. An apparatus for recording/reproducing information, comprising:
an externally-inputted information recording device for recording a record information inputted externally; and
a reproducing device for reproducing at least one of the record information and information as already recorded in the externally-inputted information recording device;
wherein, the apparatus further comprising:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.

2. The apparatus as claimed in claim 1, further comprising:
an informing device for, when it is judged that the whole of said one of the record information and the information as already recorded cannot be recorded on the recording medium, determining a required number of recording media to record the whole of said one of the record information and the information as already recorded and informing same.

3. The apparatus as claimed in claim 1, wherein:
the dividing device and the partial information recording device generate each of the partial record informations without reducing quality of the whole of said one of the record information and the information as already recorded, when it is judged that the whole of said one of the record information and the information as already recorded cannot be recorded on the recording medium.

4. The apparatus as claimed in claim 1, wherein:
the dividing device and the partial information recording device modify the whole of said one of the record information and the information as already recorded in quality thereof so as to enable the whole thereof to be recorded on a predetermined number of recording media and generate each of the partial record informations, when it is judged that the whole of said one of the record information and the information as already recorded cannot be recorded on the recording medium.

5. The apparatus as claimed in claim 1, wherein:
the dividing device uniformly divides the whole of said one of the record information and the information as already recorded so that the amount of information of each of the partial record informations is equal to the recording capacity of the recording medium.

6. The apparatus as claimed in claim 1, wherein:
said one of the record information and the information as already recorded includes audio information; and
the dividing device divides the whole of said one of the record information and the information as already recorded, at portions thereof indicative of no sound in the audio information, to generate the partial record informations.

7. The apparatus as claimed in claim 1, wherein:
said one of the record information and the information as already recorded includes dynamic image information; and
the dividing device divides the whole of said one of the record information and the information as already recorded, at portions thereof indicative of change in scene in the dynamic image information, to generate the partial record informations.

8. The apparatus as claimed in claim 1, wherein:
said one of the record information and the information as already recorded has a hierarchical structure; and
the dividing device divides the whole of said one of the record information and the information as already recorded, at portions thereof indicative of breaks of unit informations of the hierarchical structure, to generate the partial record informations.

9. The apparatus as claimed in claim 1, wherein:
said one of the record information and the information as already recorded is associated with a managing information on a basis of which said one thereof is to be managed; and
the dividing device divides the whole of said one of the record information and the information as already recorded, based on said managing information, to generate the partial record informations.

10. The apparatus as claimed in claim 1, wherein:
the dividing device divides the whole of said one of the record information and the information as already recorded so that all the partial record informations are identical in an amount of information to each other, to generate the partial record informations.

11. A method for recording/reproducing information, which is to be carried out in an information recording/reproducing apparatus comprising: an externally-inputted information recording device for recording a record information inputted externally; and are producing device for reproducing at least one of the record information and information as already recorded in the externally-inputted information recording device, said method comprising:
an information amount checking step for checking an amount of information of any one of the record information and the information as already recorded, when recording said any one thereof on a recording medium;
a recording capacity checking step for checking a recording capacity of a recording area of the recording medium on which said any one of the record information and the information as already recorded is to be recorded;
a judging step for judging, on a basis of the amount of information checked and the recording capacity checked, as whether or not a whole of said one of the record information and the information as already recorded can be recorded on the recording medium;
a dividing step for dividing said one of the record information and the information as already recorded into a plurality of partial record informations, each of the partial record informations having an amount of information, which is equal to or smaller than the recording capacity checked; and
a partial information recording step for repeating record of each of the partial record informations on the recording medium to record the partial record informations thereon.

12. A program for information record/reproduction, which is to be utilized in a computer included in an information recording/reproducing apparatus comprising an externally-inputted information recording device for recording a record information inputted externally; and a reproducing device for reproducing at least one of the record information and information as already recorded in the externally-inputted information recording device, to cause the computer to function as:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.

13. An information recording medium on which there is recorded a program for information record/reproduction, which is to be readable by a computer included in an information recording/reproducing apparatus comprising an externally-inputted information recording device for recording a record information inputted externally; and a reproducing device for reproducing at least one of the record information and information as already recorded in the externally-inputted information recording device, said program causing the computer to function as:
an information amount checking device for checking an amount of information of any one of the record information and the information as already recorded, when recording said any one thereof on a recording medium;
a recording capacity checking device for checking a recording capacity of a recording area of the recording medium on which said any one of the record information and the information as already recorded is to be recorded;
a judging device for judging, on a basis of the amount of information checked and the recording capacity checked, as whether or not a whole of said one of the record information and the information as already recorded can be recorded on the recording medium;
a dividing device for dividing said one of the record information and the information as already recorded into a plurality of partial record informations, each of the partial record informations having an amount of information, which is equal to or smaller than the recording capacity checked; and
a partial information recording device for repeating record of each of the partial record informations on the recording medium to record the partial record informations thereon.
